(19) United States
(12) Patent Application Publication
(10) Pub. No.: US 2012/0263439 A1
(43) Pub. Date: Oct. 18, 2012

(54) METHOD AND APPARATUS FOR CREATING A COMPOSITE VIDEO FROM MULTIPLE SOURCES

(76) Inventors: DAVID KING LASSMAN, Los Angeles, CA (US); JOSEPH SUMNER, Los Angeles, CA (US)

(21) Appl. No.: 13/445,865

(22) Filed: Apr. 12, 2012

Related U.S. Application Data
(60) Provisional application No. 61/475,140, filed on Apr. 13, 2011.
(60) Provisional application No. 61/529,523, filed on Aug. 31, 2011.

(51) Int. Cl. H04N 5/93

(52) U.S. Cl. 386/280; 386/353; 386/E05.028

(57) ABSTRACT

The present system provides a method for a group of people, related or otherwise, to record an event on separate recording devices. The video from those recording devices can then be synchronized with each other. After synchronization, a composite movie is automatically generated using extracts from all or some of the video recordings. The composite movie is returned to a mobile device from where it can be shared and broadcast or re-edited inside the device.

This patent application claims priority to U.S. Provisional Patent Application 61/475,140 filed on Apr. 13, 2011 and U.S. Provisional Patent Application 61/529,523 filed on Aug. 13, 2011, each of which is incorporated by reference herein in its entirety.

### BACKGROUND

There are a number of situations where a number of people are having a shared experience and it would be desirable to have a video record of the experience. In the current art, this would involve one or more of the participants recording the experience, such as with a video camera or a smart-phone or some other mobile device. The person making the recording might then forward the video to others via email or a social media website, twitter, YouTube, or the like. If two or more people made recordings, the different recordings might also be shared in the same manner.

For one of the participants, or for someone who was not part of the experience to relive the moment, the person would need to find and play the video recordings. In most cases, the recordings might not be stored together in one location, and the person would need to track them down and view them one at a time. Even then, the entire experience might not be captured, because it is rare that a person will video an entire experience because they themselves usually wish to participate in the experience.

In other instances, the people at the experience might not know others who are sharing the same experience. It would be chance if a person were to stumble upon a video of the experience made by a stranger. And again, the process of viewing separate videos may result in an incomplete record of the experience.

### SUMMARY

The present system provides a method for a group of people, related or otherwise, to record an event on separate recording devices. The video from those recording devices can then be synchronized with each other. After synchronization, a composite movie is automatically generated using extracts from all or some of the video recordings. The composite movie is returned to a mobile device from where it can be shared and broadcast or re-edited inside the device.

### BRIEF DESCRIPTION OF THE DRAWINGS

FIG. 1 is a flow diagram of an embodiment of the system.

FIG. 2 is a flow diagram of an embodiment of content acquisition in the system.

FIG. 3 is a flow diagram of an embodiment of the video compositing step of FIG. 1.

FIG. 4 is a flow diagram illustrating the compositing of video on a handheld device.

FIG. 5 is a flow diagram of an embodiment of initiating a group recording.

FIG. 6 is a flow diagram of another embodiment of initiating a group recording.

FIG. 7 is a flow diagram of another embodiment of initiating a group recording.

FIG. 8 is an example of a playback grid for editing content using the system.

FIG. 9 is a flow diagram illustrating an embodiment of the hold tap gesture.

FIG. 10 is a flow diagram illustrating an embodiment of the system playback using the hold tap gesture.

FIG. 11 is a flow diagram illustrating an embodiment of the system for automatic composite generation using random clip selection.

FIG. 12 is a flow diagram illustrating and embodiment of the system for automatic composite generation using user statistical data.

FIG. 13 is a flow diagram illustrating and embodiment of the system for automatic composite generation using user preferences.

FIG. 14 is a flow diagram illustrating and embodiment of the system for automatic composite generation using quality metrics.

FIG. 15 is an example of an implementation of the system.

FIG. 16 is an example computer environment for implementing an embodiment of the system.

### DETAILED DESCRIPTION OF THE SYSTEM

The system provides a system where a plurality of users can combine video from a common event and edit it manually or automatically into a composite video segment. The editing may be accomplished In the following description, the operation of the system is described by reference to recording a concert performance. However, this is by way of example only. There are other situations where it is desired to combine media resources into a composite. For example, at any public gathering, sporting event, wedding, or any other situation where two or more people may be recording an event. It need not even be people alone recording an event. The system has equal application where security cameras or other automatic recording devices are combined with other unmanned recording systems and/or with human controlled recording devices.

Consider a wedding where the married couple establishes a website or address into the system for purposes of combining media content from attendees at the wedding and/or reception. The system can be used to provide additional perspectives and views in addition to, or combined with, any official videographer or photographer. For purposes of the following description “performance” should be read to cover any situation, event, or experience where there are two or more content recordings of any type.

Concert Embodiment

In the context of a concert, all system users can upload their recordings of a live show to a common location. All of the footage is then available to all system users. A dashboard is provided to allow the system users themselves to generate a full length video of the performance using a computer or a smart-phone, pad computer, PDA, laptop, and the like. Alternatively, the system user may just desire a subset of the performance, e.g. the system user's favourite songs or moments. In another embodiment, the system may automatically generate a composite video based on various metrics.

After the video is defined by the user or the system, the system adds a soundtrack from the actual performance. The soundtrack may be a professionally recorded soundtrack from the concert itself or it may be source audio from the plurality of recordings. In the context of a concert, the performer may agree to record each performance (this is done typically anyway) and this high quality audio track becomes available to the system user. Even if the system user does not want to use other fans' video segments, preferring to use only the fan's own recording, the recording can be augmented with a synchronized and professional soundtrack so that an improved recording is provided. In other embodiments, a system user may use only the soundtrack from the user's own footage or the footage of others to create a soundtrack for the composite video.

In some embodiments, the service can be obtained before, during, or even after a performance. In other embodiments, the service is included as part of the ticket price and the fan uses information on the ticket to utilize the site.

By way of example, the system described in the following examples refers to the recording of content using a smart-phone. However, the system is not limited to the use of smart-phones. Any device that is capable of recording and transmitting content back to a server may be used without departing from the scope and spirit of the system, including, but not limited to, tablet computers and devices, web enabled music players, personal digital assistants (PDA's), portable computers with built in cameras, web enabled cameras, digital cameras,and the like. Any time the term smart-phone is used, it is understood that other devices such as those described herein may be used instead.

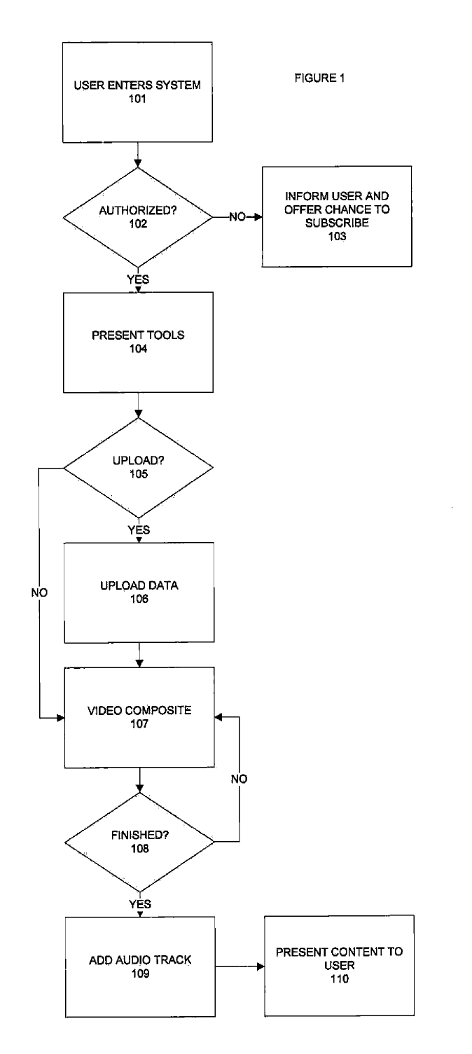

FIG. 1 is a flow diagram illustrating the operation of an embodiment of the system. At step 101 the user logs into the system and either selects an event or the system knows that the user is at that event. This can be done via a website from a computer or via a smart-phone or other portable computing device, such as a pad computer, net-book and the like.

At step 102 the system determines if the user is an authorized system user for that event. In some embodiments, availability of the system is tied to specific events at which the user purchased a ticket In other embodiments, a system user may have access to all events that are associated with the system. In yet other embodiments, each event on the system has an access price and the user will elect to pay the access price for the event.

The system creates groupings of associated content. Typically, the content is from some event or performance and the content is created by users at the event. In other cases, a grouping of content is defined using some other metric. In this system, a grouping of associated content is also referred to as a “shoot”. An individual piece of content that is part of the shoot is referred to as a “clip”, a “source” or other similar terms.

If the user is not authorized at step 102, the system informs the user at step 103 and offers the user a way to become authorized, such as by subscribing or paying a particular event fee. If the user is authorized, the system proceeds to step 104 and presents an interface to the user that includes available content and data from the selected event.

At step 105 it is determined if the user has content to upload. If so, the system uploads the data at step 106. After step 106 or if the user does not have content to upload, the system proceeds to step 107 and the video compositing is performed. In this step, the user selects from available video sources for each stage of the event in which the user is interested. In another embodiment, the system selects the video sources for use in the compositing step. If, for example, the user is interested in a particular song in a performance, all video sources for that song are presented. In some cases, the system indicates which sources are available for which section of a song, as some files will not encompass the entire song.

At step 108 it is determined if the user is done with the video compositing. If not, the system returns to step 107. If so, the system proceeds to step 109. At step 109, the audio track is merged with the video composite that the user has generated. At step 110, the finished content file is provided to the user.

Mobile Device Application

In one embodiment of the system, an application is made available for downloading to a smart-phone or other recording device. The application is integrated with the recording software and hardware of the device. In one embodiment, the system is automatically invoked anytime the user makes a recording. In other instances, the user can elect to invoke the system manually as desired.

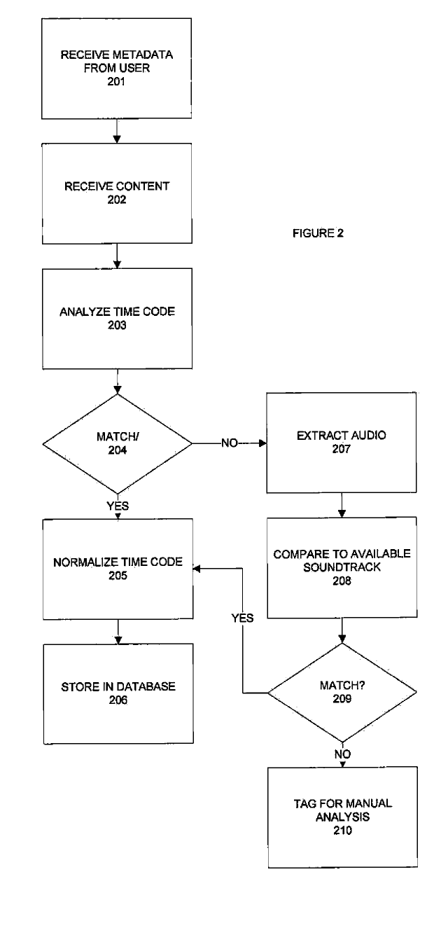

FIG. 2 is a flow diagram illustrating the acquisition of video data from a user during an event or experience. At step 201 the system receives data that a user is making a recording on a system-enabled device. This notification occurs even if the user is not streaming the video to the system, and even if the user does not later upload video data to the system. When the user begins recording video, metadata is sent from the device to the system identifying the user, the time, and any geo-location information that might be available. In some cases, as described further below, the system can identify a group of users who appear to be recording at the same event, even when the users do not specifically identify a particular event.

At step 202 the system receives the video data from the user and associates meta-data with the content, including, but not limited to, the event time and date (in the case of the recording of a performance), the performer, the location of the device used to capture the event (e.g. seat number, if available, or other information provided by the user such as general area of the audience, stage left, center, stage right, or by geo-location information provided by the recording device or smart-phone) and any other identifying characteristics that may be provide by the user, such as section of the performance that the clip is from, the name of the song or songs that are included in the clip, the type of device used to make the recording, and the like. The clip may have a time code associated with the recording.

As noted above, when the user invokes the system and records a clip, the user may not decide to upload that clip immediately or to stream the clip automatically. Even so, the system will communicate the start time and stop time of the recording to the system so that a placeholder can be created at the system level. When the video data is later uploaded, the system already has created a file associated with the content.

When the system receives the content, it transcodes the content into a codec that can be more easily used by the system (e.g. MPEG2). For transmission, the system in one embodiment uses the H264 standard. At step 203 the system analyzes the time code to determine if it can be used to synchronize the clip with other clips from the same event or experience. That, is, if the user has a proper time and date on the recording device such that it substantially matches the time code of the audio recording of the event. At step 204 the system determines if the time code matches. If so, the system normalizes the time code at step 205 so that the clip is now associated with the appropriate time portion of the event. At step 206 the clip is stored in a database associated with the event.

If the time code of the clip does not substantially match the event time code at step 204, the system uses the time-code recorded on the system server at the point of recording. If there is no satisfactory result the system proceeds to step 207. At step 207 the system extracts audio from the clip. At step 208 the system compares the audio to other audio available from the event to determine when in the event the clip is associated. (Note that the available audio may be source audio from other recordings, or it may be a recorded soundtrack in the case of a performance.) At step 209 it is determined if a match is found. If not, the clip is tagged for manual analysis at step 210. If so, the system proceeds to step 205.

In this manner, a collection of content segments (e.g. clips) are sorted and ordered and placed in position on a universal timeline of the event. Each clip is assigned a start time and end time. The start time is related to the earliest start time of any of the associated clips. In one embodiment, the earliest clip is given a start time of 0:00 and all later starting clips are given start times relative to that original start time. In one embodiment, the system links as many clips as possible where there is continuous content from an origin start time to the end time of the latest recorded clip. In other embodiments, the system assembles clips based on a start time and end time of the entire event, even if there are gaps in the timeline. A set of continuous linked clips may be referred to as an event, or a shoot.

FIG. 3 illustrates an embodiment of the video compositing step of FIG. 1. At step 301 the user identifies where in the timeline of the event the user is interested in creating a composite video. For example, it may be from the beginning, it may be one or more sections of the event (e.g. songs during a performance), or some other point in the event. At step 302 the system retrieves all video clips that have time codes that are coincident with that section of the event. For example, the clips may begin, end, or encompass that particular starting point. Each clip is then cued to the particular time point at step 303. This is accomplished by taking advantage of the normalized time codes that are created upon intake of the clip, and the meta-data that is associated with the clip.

At step 304 the clips are presented to the user via a dashboard interface. The interface may include a time line of the event with some markers indicated so that the user can easily identify portions of the event. In one embodiment, the user can zoom in to a region of the timeline to reveal more information about the timeline, (such as, in the case of a performance, verse, chorus, instrument solos, and the like). In other instances as described below, the system provides the video in a grid array with video from submitted clips playing back in different areas of the grid.

As the content plays, the clips are updated to show the image of each clip associated with the point in time. As playback proceeds, clips may appear and disappear from the display depending on whether they have content associated with that particular time of the event.

At any point during playback, the user can select a clip at step 305 and make it “active” for that portion of the timeline. By selecting clips during playback, the user can create a unique and personal record of the performance, using clips uploaded by the user or others.

At step 306 the system determines if the user is done. If not, the system returns to step 305. If yes, the system collates the selected clips and renders them into a composite video at step 307. It should be noted that the user may select edit transitions (fade, wipes, iris, and the like) as desired. At step 308 the system adds a soundtrack to the clip and at step 309 presents it to the user. The system can also operate independently of the audio track, using time code information from the various clips, often provided by, for example, a smart phone or time code information on the system server.

Once a composite video is created, the system includes metadata associated with the composite so that all content sources are still identifiable in the composite video.

The audio matching is made easier by the normalization of the time codes in the video clips. After a composite video is assembled, the system checks the start and end time codes and adds the appropriate audio track to the composite video, based on those time codes.

In some embodiments, such as in the case of a performance, the performer or the rights holder to the relevant content can arrange for their own video recording of a performance, which may be made available to the user as part of creating a composite video. This can be useful when there are gaps in the submitted content.

In other embodiments, a composite video may be generated automatically from the plurality of video clips and then distributed to system users.

Composite videos can be made available outside the network (in a controlled way) on social media sites and video broadcasting sites like. YouTube. Revenues generated through charges associated with certain events and performances will be audited and royalties paid using existing performance rights societies. In some instances, new forms of license will be created to accommodate this.

In one embodiment, composite videos can be streamed live to users via the Internet. The system may, in one embodiment, provide Special Areas from where system users can record events. System users will be issued with passes (online or at the venue) to provide them access to these areas, in some instances directly to their smart-phones.

Geo-locaters can be used to pinpoint system users at an event. This data can be used by the system in assembling composite videos.

Alternate Synchronizing

In an alternate embodiment of the system, video clips can be synchronized without relying on audio tracks. This embodiment can be applied to synchronizing video from smart phones, for example, and creating videos of any type of event, not limited to music performances. For example, the video from recording devices such as smart phones at sporting events, small gatherings, or any other type of event where two or more users might be recording video.

In this embodiment, the system can use the time code from the smart phones (typically the smart phones receive time signals via wireless transmissions that provide correct time and date). Thus, the video and location tracking information provided by a smart phone can be used to assist in synchronizing video clips taken from different smart-phones.

The system can then present these multiple video clips in association with a timeline so that a user can choose which clip to use and will be able to piece together a continuous synchronized composite video of an event, regardless of whether there is sound or not.

To assist the user, the system also contemplates a recording application that can be downloaded onto a smart phone. The recording App can record and upload automatically to the server. In addition, the App can automatically generate a wide range of metadata (geo location, timestamp, venue, band, etc). In addition, it may include a payment mechanism so that purchases can be made on a per-event basis.

In another embodiment, the system can utilize near field communication to synchronize a local network of smart-phones so that content synchronization can occur without the need for soundtrack synchronization.

Local Compositing System

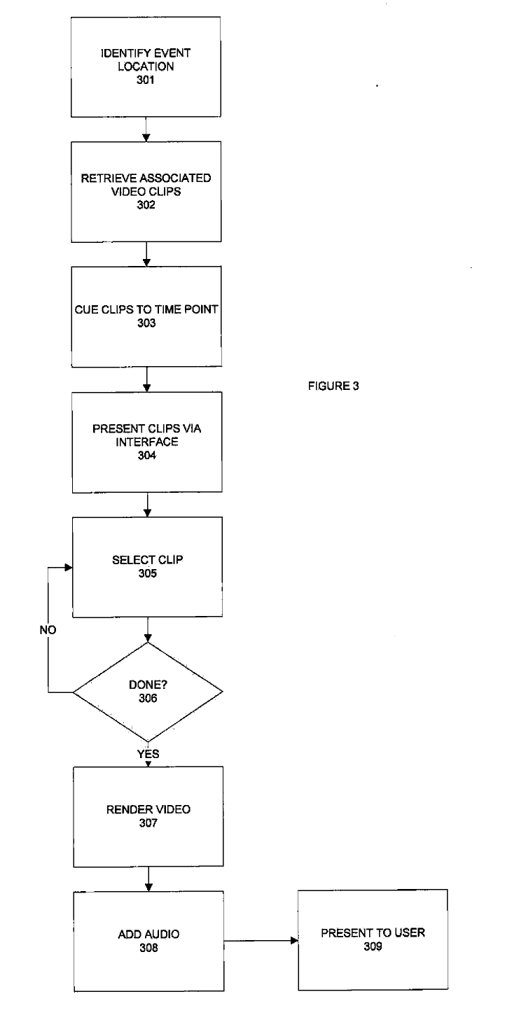

In one embodiment, the system allows the compositing of content using a hand-held device such as a smart-phone, pad computer, net-book, and the like. This embodiment is described in the flow diagram of FIG. 4. At step 401 two or more devices capture content (image and/or audio). At step 402 the users submit their content to the system.

At step 403, the system collects and associates content from the same event. This can be accomplished in a number of ways. In one embodiment, the system takes advantage of the geo-location tracking capability of a smart-phone and assumes that content with a similar location and taken at approximately the same time belongs together. This can be especially useful when users are submitting content that results from some spontaneous event such as a breaking news story and the like. In other embodiments, the system allows users to self-identify an event and to tag the content so that it is associated with other content from the same event. In yet other embodiments, some other party has defined an event in the system (such as a concert or other performance) and the incoming content is submitted to that defined event and/or location tracking and other temporal information is used to associate the data with the event.

At step 404 the system analyzes the data associated with an event and normalizes the content and defines a timeline. The data available is then associated with the time line. At step 405 the system creates a light version of the information that can be transmitted or streamed to a smart-phone. That is, the system creates a lower resolution and/or lower bit rate version of the content so that it can be sent back to the user more quickly with less bandwidth load.

At step 406, the user of the smart-phone is presented with a plurality of windows playing back the content. Each window presents the data from one source as long as data is available for that source. If a source ends and another source is available, the system replaces the first clip with the next clip. If there are gaps in the content from one source, the window associated with that source will be blank at times.

In one embodiment, the system allows the user to determine how many playback windows will be enabled on the smart-phone. For example, because of display size limitations, the user may not want more than four or six windows. FIG. 8 is an example of a playback grid presented to the user on a smart-phone. In the example of FIG. 8, the system presents clips to the user in a 2×2 grid of playback windows.

At step 407, the user initiates playback on the device. Any window that has content available at that point in time is played back in one of the grids. Each window in the grid can be repopulated by a new clip if the prior clip has expired. As playback proceeds, each window in the grid begins to play at the proper time. It is contemplated that all four windows will be playing back simultaneously, with different views of the event presented based on the location of the device recording the clip.

At times there may not be clips available for every playback window in the grid. When that occurs, in one embodiment, the system disables the ability to select that window with an editing command so that there will be no dead spots in the composite video. If the user selects an unpopulated playback window during the editing process, the request is ignored and no edit takes place.

During playback, the user simply taps on one of the windows to select that view as the selected view for that portion of the composite video. That clip is the chosen clip until the user taps on another window or that clip expires. If the user has not selected another clip, at that time, the system will choose another clip so that the composite video is continuous. This selection may be random or based on the longest available clip or any other process to provide continuous content in the composite video.

When the user taps on another window, the system switches to that content as the content to include in the composite video. The system logs time-code and source information (i.e. start/stop times and content source) whenever the user taps a playback window. This is referred to herein as a “cue”. At the end of the content playback, at step 408, the system offers the user the opportunity to review the composite generated by the users action. If the user wants to see the playback, the system proceeds to step 409 and, using the start/stop and source data collected, presents a full screen composite playback locally at the smart-phone to the user. The playback is a live real-time preview.

If the user does not want to see playback, or after the playback at step 409, the system determines if the user accepts the composite at step 410. If not, the system returns to step 407 so the user can try again. If so, the system proceeds to step. 411 and transmits the cues to the system and builds the composite at maximum quality allowed for by the ssytsem for eventual transmission to the user.

Although the example above is described with a 2×2 grid, the system can be implemented with larger grids if the user desires. For example, when the user edits on a desktop computer or a tablet computer, the user may desire a 3×3, 4×4, 5×5 or any other suitable grid as desired.

Whether content editing is done on a desktop or on a mobile device, the system allows the playback to be slowed down to make it easier for the user to select clips. The user can switch back and forth between slow, normal, and fast playback during the editing process as desired, or manual dragging as described below.

Referring again to FIG. 8, each window of the 2×2 grid has an identifier associated with it. This identifier could be a unique border pattern or color, some iconographic indicator in the corner of the window, or even a numeric indicator. In the example, shown, numeric indicators are used in the corner of each playback window. As the user creates a composite video by tapping one of the playback windows to define an edit point, an indicator is placed on the timeline below the display. The timeline represents the playback time of the entire composite clip and a playback window indicator is inserted wherever the user has selected that window as the chosen content for that portion of the composite video.

In the example shown in FIG. 8, the user has begun with the content from playback window 1, switched at some later time to the content from window 2, switched back to 1, then to window 3 and finally to window 4. It should be noted that the playback window indication does not necessarily refer to a single content clip, as a window may switch from clip to clip if the first clip has finished and another clip is available. The system tracks all the source content automatically.

After editing and during playback on the mobile device while still in editing mode, the window indicators are shown on the time line. If desired, the user can select any of the indicators and drag them left or right to change the start time or end time of the edit point. Because the reduced version of the video and the composited video is available locally on the device, the change can be updated automatically. If the user attempts to move the start or stop point of an edit point of a playback window to a time in which that window did not have any content available, the system will disallow that and stop the drag operation at the furthest available point.

In one embodiment, the video provided to a user is a single video assembled at the system from the various uploaded video files. The video is at the reduced resolution and/or bit rate so that downloading to the mobile device is enhanced. The system assembles the data so that it appears that four playback windows are provided, although it is in fact a single video. The system tracks the touch screen location associated with the four quadrants of the display during editing playback and notes the touch location (identifying the quadrant) and the start and stop times of each edit point. On local device playback of the composite video edited by the user, the system still uses the originally transmitted file but uses zoom commands to bring up the appropriate quadrant to full screen size, while still using the original data stream.

When the composite video is returned to the system and the full resolution video is assembled, the cues and sources at the full resolution are assembled and returned to the user (or shared to the desired location at the option of the user).

Associating Content

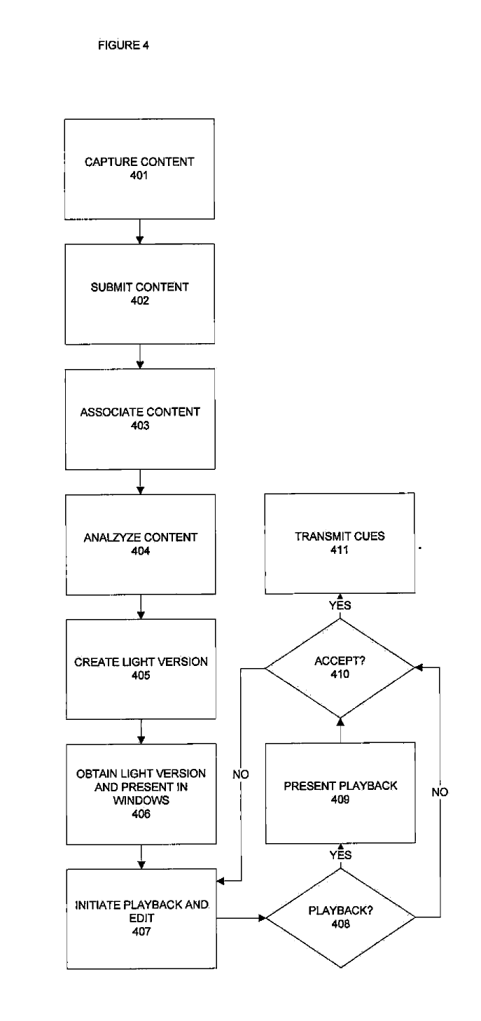

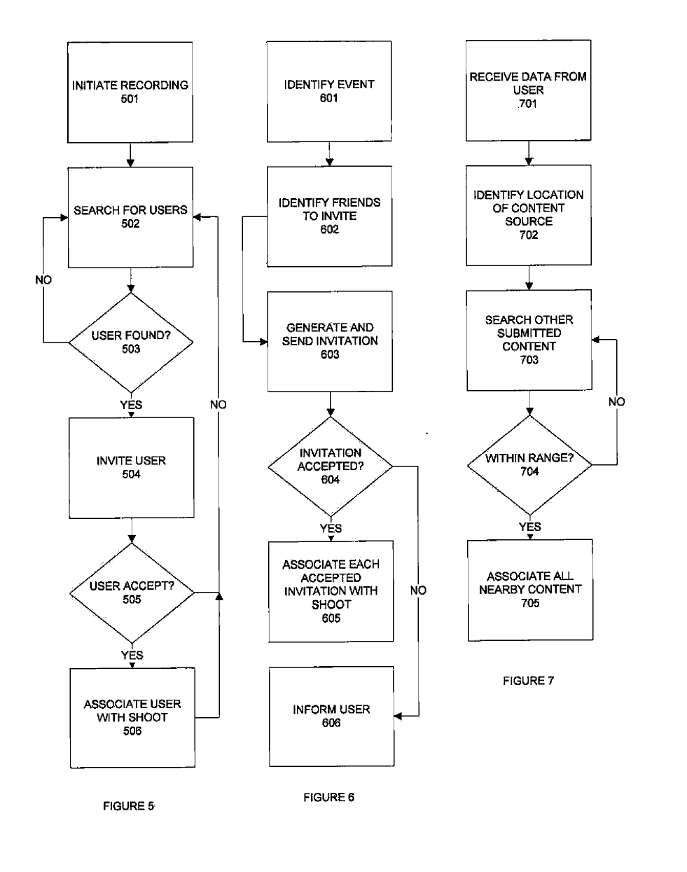

The system contemplates a number of ways to enable the generation and association of content at an event. Embodiments of different approaches are described in the flow diagrams of FIGS. 5, 6, and 7.

Referring to FIG. 5, a user initiates recording of an event using, for example, a smart-phone. When the system is invoked, the system receives notification and begins searching for other system users within a predefined distance from the original user. In some embodiments this may be 150 feet or some other distance. In one embodiment, the user themselves can define the range of distance in which to look for other system users to compensate for smaller or larger locations. The detection of users within the desired range is accomplished in one embodiment by the use of geo-location technology on the smart-phone of each system user.

At decision block 503 the system determines if a system user has been found. If so, the system sends an invitation to the system user at step 504 to invite the user to participate in the shoot. At decision block 505 the system determines if the invited user has accepted the invitation. If so, the system associates the responding user with the shoot at step 506 and adds any content from that user to the pool of available content for compositing.

After step 506, or if there are no users found at step 503, or if the user declines the invitation at step 505, the system returns to step 502 and continues to search for users during the shoot.

FIG. 6 is a flow diagram illustrating another embodiment of associating system users during a shoot. At step 601 a user invokes the system and identifies an event for which the user desires to shoot content. At step 602 the user identifies friends that the user wishes to invite to join in the shoot. At step 603 the system generates and sends invitations from the user to the one or more friends to be invited.

At decision block 604 the system notes whether the invitation has been accepted. If so, the system proceeds to step 605 and associates all accepted invitations with the shoot. If not, the system informs the user at step 606.

FIG. 7 illustrates still another method for associating content. At step 701 the system receives metadata and/or content from a system user. At step 702 the system identifies the location of the content source. This may be accomplished using geo-location or by metadata associated with the submitted content or by some other means. At step 703 the system searches through other content being concurrently submitted and determines its location. Alternatively, the content may not be streamed to the system during the event. In that case, the system can review all content and look for location information and temporal information to determine candidate content that may be from a particular event or shoot.

At decision block 704 it is determined if the other content is within some predetermined range of the original content. If so, the system associates all content within the range together as part of a single shoot. If not, the system returns to step 703 and continues monitoring submitted content. In this embodiment, the system can aggregate content of system users at the same event even when those users are not specifically aware of each other. In some embodiments, a system user may opt to only share content with invited friends. In that case, such restricted content would not be aggregated without permission.

Legacy Content

In one embodiment of the system, it is possible to associate older clips with a particular shoot or to assemble older clips into a group to be defined as a shoot. The source of these clips may be content from user recording devices. In other instances, the content could be existing on-line content, such as found in media sharing sites such as YouTube and other web video sites. In this embodiment, the system can perform sound matching on legacy clips to enable the system to synchronize the clips with existing or newly created shoots. In this embodiment, the system could combine clips from different events (e.g. different concert performances of the same song) and allow the user to create a composite video from legacy clips even though the content is from different events.

Lip Synch

In one embodiment of the system, a user may upload a video of the user (or other(s)) singing along with a performer's song. The user can upload the lip synch video to the system and the system can associate all other lip synch videos of that song into a shoot. The content of that shoot can be presented to users for editing as noted above, creating a composite video of different users singing along with a song. In one embodiment, the system can do automatic editing of the available lip synch videos as well.

Rating

The system contemplates the ability to rate composite videos as a whole, or in part. For example, when presented on a device with a touch screen display, such as a smart-phone or tablet computer, a user can “like” a particular portion of a composite video by the use alone or more gestures. In one embodiment, the system contemplates a “tap to like” gesture and a “hold tap” gesture. A tap to like gesture is a tap on the display when the user likes a particular section of the video. Because the user may have some delay in effecting the gesture, the system will identify a certain amount of video before and after the tap to like gesture as the liked portion (e.g. 3 seconds on either side of the tap to like gesture). In the case of the hold tap gesture, the user touches the screen during playback and holds the tap in place. The user holds the tap as long as the user desires to indicate a portion of a clip that the user likes. The system records this like rating and generates statistical data

FIG. 9 is a flow diagram illustrating the operation of the gesture mode of the system. At step 901 the system presents a composite video to a user. At step 902 the system places the region of the screen on which the playback is taking place into a mode where a tap gesture can be recognized. In some cases, the device may initiate some default operation upon screen tap unless the system overrides that default operation.

At step 903 the system detects a tap gesture by the user. A quick tap is a tap to like and a longer tap is a hold tap. At step 904 the system identifies the source and time information of content associated with the tap gesture (e.g. some content around a tap to like, and the start and stop time of a hold tap). In some cases, this may encompass content from a single source or from two or more sources, depending on when in playback the gesture is made.

At step 905 the system updates statistics associated with the liked sections. This includes updating statistical data for the specific composite video as well as any shoots that include the liked content. In one embodiment, this may be the creation of a histogram of likes for each clip of a shoot. Other statistical data can be generated as well. In one embodiment, the system updates a system copy of the composite video with the number of likes for each portion of the composite video. During subsequent playback, the system can display the number of likes at each moment of the video. Some badge or indicator can represent particularly well-liked sections, such as with a flashing icon or some color indicator.

It should be noted that the rating gesture is not limited to the present system, but may be utilized in any system where a touch screen is available during playback of content. In some embodiments, the system can detect the exact screen location of the rating gesture and associate and indicator at that location when the rating is shared with others, allowing the user doing the rating to also indicate particular features of a video that might be of interest.

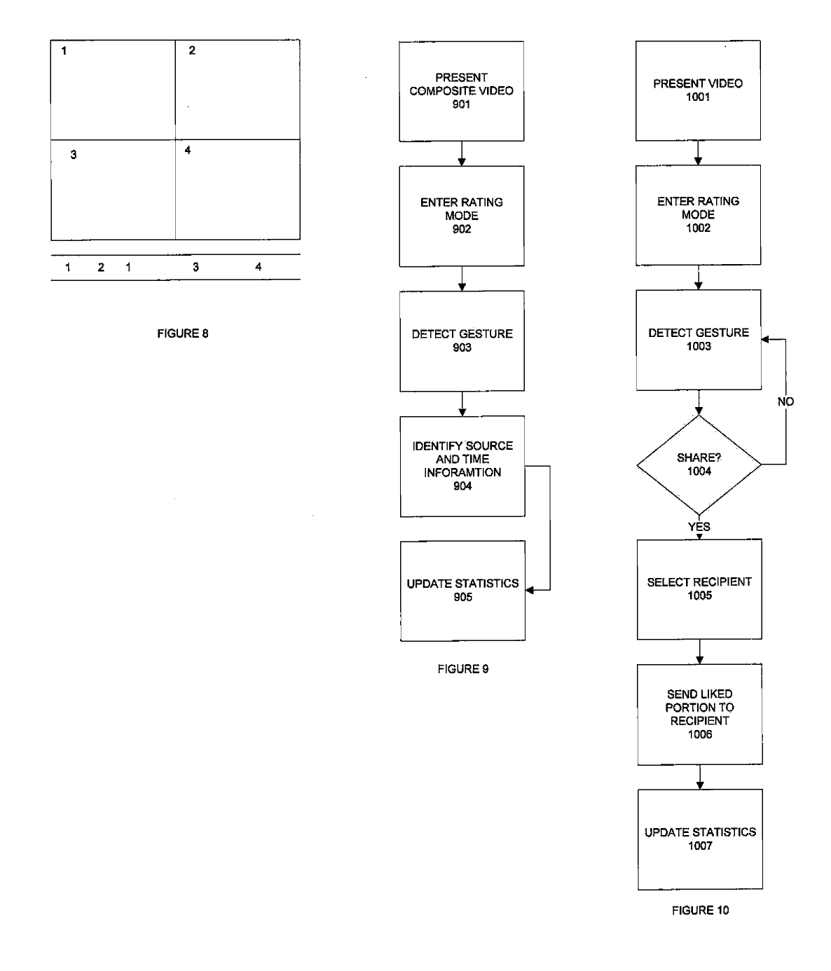

FIG. 10 illustrates another embodiment of the system using the rating gesture. At step 1001 the system presents a composite video to a user. At step 1002 the system places the region of the screen on which the playback is taking place into a rating mode where a tap gesture can be recognized.

At step 1003 the system detects a tap gesture of either type by the user. At decision block 1004 the system asks the user if the user would like to share the liked portion of the video. If not, the system continues detecting rating gestures at step 1003. If so, the user selects a recipient at step 1005. A recipient can be one or more contacts of the user and/or a social media site (e.g. facebook, twitter, and the like).

At step 1006 the system sends the liked portion to the selected recipient. At step 1007 the system updates the statistics associated with any clips in the liked portion.

In one embodiment, the system defines the liked portion of the video as the content that is played while a hold tap is held. In another embodiment, the system also adds some amount of time before and after the hold tap gesture to aid in implementing the intention of the user.

Automatic Video Editing

In one embodiment of the system, the user can allow the system to automatically generate a composite video. This can be accomplished in a number of ways. For example, the system can randomly switch between clips available at each point in time of the shoot, with some minimum number of seconds defined between cuts. In another embodiment, the system relies on the “likes” of each clip to generate a composite video. In another embodiment, the system can accept metrics from the user to automatically identify clips to use in the compositing. In other instances the system can look at quality metrics of each clip to determine which clips to use.

Random Clip

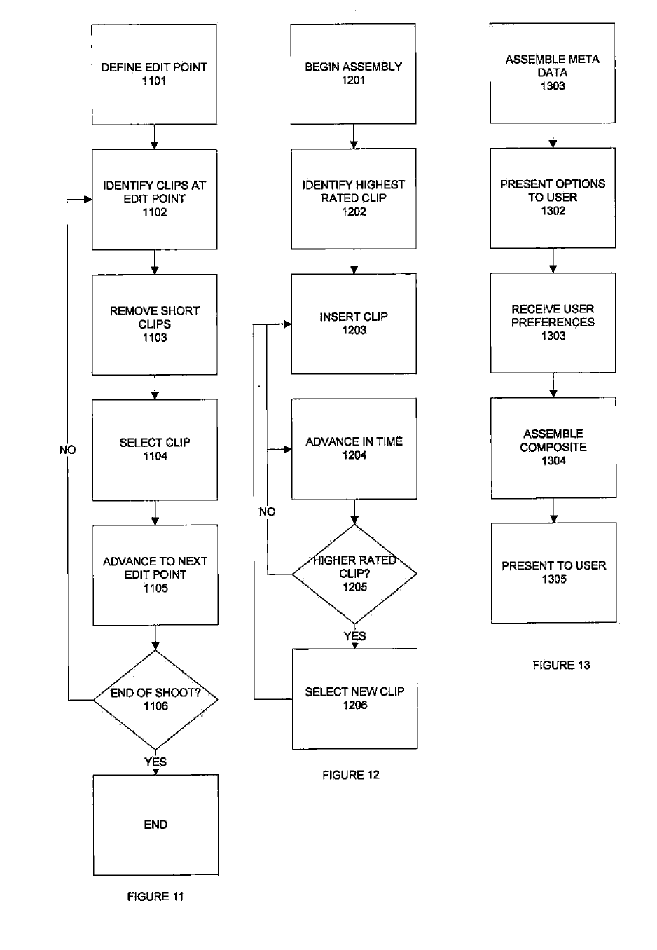

FIG. 11 is a flow diagram illustrating the generation of an automatic composite video using random clip selection. At step 1101 the system defines an edit point at which to select a clip. In some cases, this will be the beginning of the earliest clip available in the shoot. In other cases, it may be the beginning of the actual performance or event. At step 1102 the system identifies all clips that have data at that edit point. At step 1103 the system de-prioritizes all clips that are short. The system will define a minimum time between edits, so any clip that does not contain enough content to reach the next edit point is too short.

At step 1104, the system randomly selects from the available clips after the filtering at step 1103. (Note, if there are no clips that satisfy the timing requirement, the system will select the longest available clip, even though it is shorter than the desired minimum time between edits.). The system selects content from that clip to the next edit point at step 1105. At decision block 1106 the system determines if it is at the end of the shoot. If so, the system ends at step 1107. If not, the system returns to step 1102 and identifies clips at the next edit point.

Statistical Data

FIG. 12 is a flow diagram illustrating the automatic generation of a composite video based on statistical data associated with the clips. At step 1201 the system begins assembling the composite at some beginning point. At step 1202 the system identifies the highest rated clip that is available at that point in time. This may be from user indications of likes by some means, such as the hold tap described above. At step 1203 the system inserts the clip into the composite video.

At step 1204 the system advances in time some defined amount. At decision block 1205 the system determines if there is a higher rated clip at that point in time. If not, the system continues with the previously selected clip and returns to step 1204. If there is a higher rated clip at decision block 1205, the system selects that clip at step 1206 and returns to step 1203, where the new, higher rated clip, is inserted into the composite video.

The system of FIG. 12 can be continuously updated so that as ratings change for different portions of the shoot, the system updates the automatically generated composite video to reflect the most highly rated clips.

User Preferences

FIG. 13 is a flow diagram illustrating the automatic generation of composite video using user preferences for various characteristics. At step 1303 the system assembles metadata associated with the shoot and with each clip. This data may be available from a number of sources and may be automatically generated or may be manually generated. In some cases, a user may tag their own clip with metadata prior to submitting it to the system. In other cases, personnel at the system may review clips and provide metadata. Examples of metadata may include location of the person recording the content, identity of persons in the clip, and the like.

In one embodiment, the system analyzes the sound from a clip to automatically identify the instruments that are present in the clip and adds that information to the metadata associated with the clip.

At step 1302, the system presents a list of available metadata that applies to the clips of the shoot to the user. At step 1303 the user selects those preferences in which the user is interested. For example, the user may only be interested in clips shot from close to the stage, or from the center, or from some other location. In other cases, the user may be interested in all clips that feature a particular person in the shoot. In some cases, the user may desire that whoever is speaking (or singing) be seen in the clip.

At step 1304, the system automatically assembles a composite video using the user preferences to select from available clips at each edit point. Where there is no clip available at a certain edit point that satisfies the user preferences, the system may select a replacement clip using any of the techniques described herein.

Extracted Features

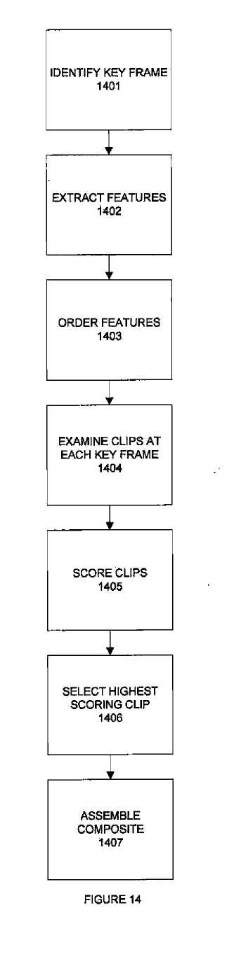

FIG. 14 is a flow diagram illustrating the operation of the system in automatically generating a composite video using extracted features. At step 1401 the system defines a key frame in the shoot and acquires clips that have content at that key frame. At step 1402 the system extracts features from the available clips at that key frame. Examples of the features that can be extracted include, but are not limited to, hue, RGB data, intensity, movement, focus, sharpness, brightness/darkness, and the like.

At step 1403, the system orders the extracted features and weights them pursuant to the desired characteristics of the automatically composited videos. At step 1404 the system examines the clips available at each key frame. At step 1405 the system scores each available clip pursuant to the ordered features from step 1403.

At step 1406 the system selects the highest scoring clip and assembles the composite video using that clip at step 1407.

System Architecture

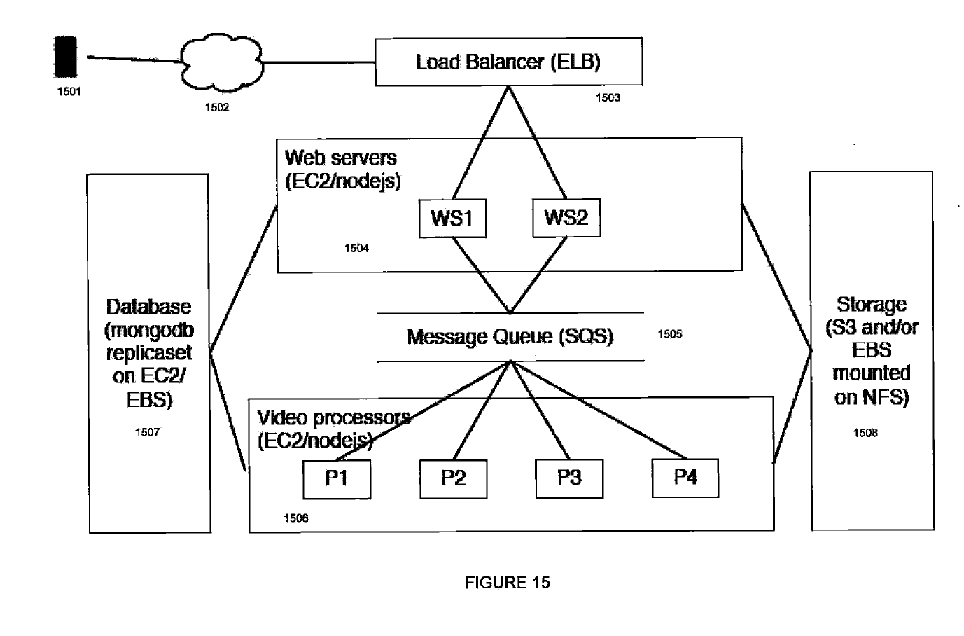

FIG. 15 illustrates an example of an embodiment of the system. A user-recording device (e.g. smart-phone) communicates with the system through a network 1502 (e.g. the Internet). In one embodiment, the system uses cloud computing to implement the collection and editing of content and all other operations. The data and communication from the user device is first coupled to Load. Balancer 1503 which is used to assign tasks to different servers so that no server is starved or saturated. In one embodiment the Load Balancer 1503 employs a round robin scheme to assign requests to the servers.

The Web servers 1504 comprise a plurality of servers such as WS1 and WS2. In one embodiment these servers handle data requests, file uploads, and other lower overhead tasks. High load tasks are communicated through Message Queue 1505 to Video Processors 1506. The Message Queue collects video processing requests and provides information necessary to determine if scaling of video processing resources is required.

The Video Processors 1506 comprise a plurality of processors P1, P2, P3, P4 and up to Pn depending on need. In one embodiment the system uses Amazon Web Services (AWS) for processing. In this manner, the system can auto-scale on demand, adding more processing capability as demand increases, and reducing processing capability as demand decreases.

Storage is provided by NFS storage 1508. This is where uploaded files can be stored. An EBS database 1507 is provided to track shoots and associated videos and associated metadata, ratings, tags, and the like. The database also stores user information, preferences, permissions, as well as event, performer, and other content owner data, calendars of events, and the like. To reduce the need for storage space, all original content is maintained in storage, but system generated content is deleted after some time period. The edit points of composite videos are maintained so that a composite video can be regenerated as needed.

Although one embodiment of the system utilizes cloud computing, the system can be implemented in any processing system.

Data Structures

In one embodiment of the system, clip data is stored with associated data in a data structure, including, but not limited to, time, date, location, offset data (based on synchronized shoot), resolution, bit rate, user/uploader, ratings, and any tag or metadata associated with the clip.

Embodiment of Computer Execution Environment (Hardware)

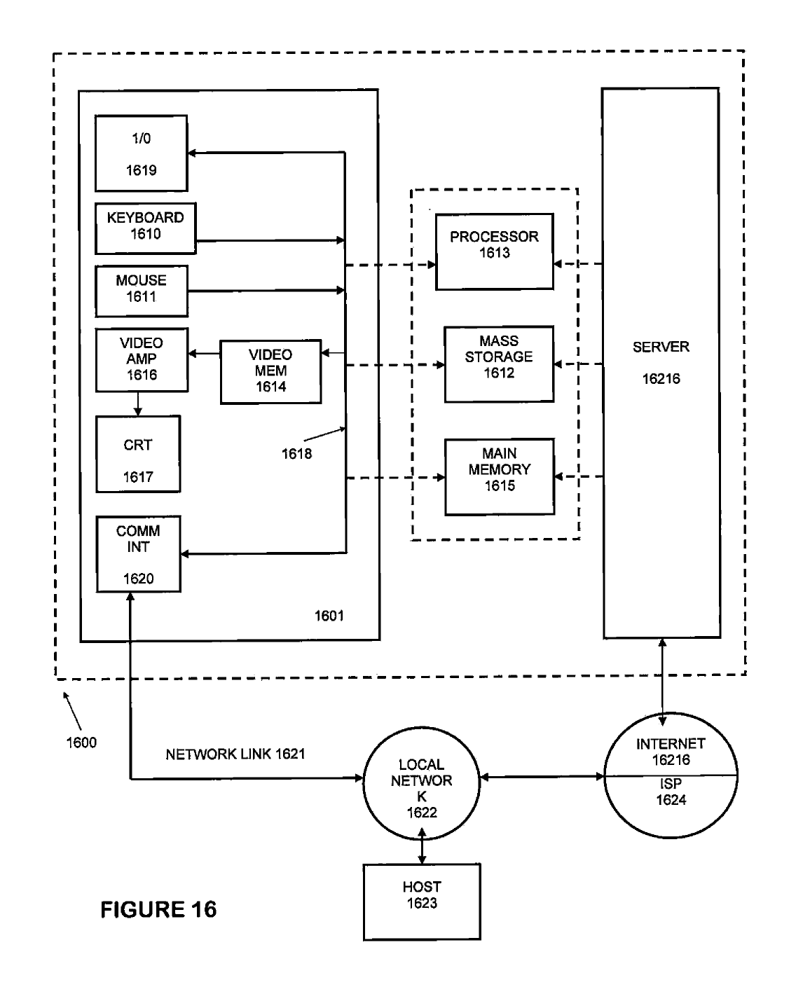

An embodiment of the system can be implemented as computer software in the form of computer readable program code executed in a general purpose computing environment such as environment 1600 illustrated in FIG. 16, or in the form of bytecode class files executable within a Java.™. runtime environment running in such an environment, or in the form of bytecodes running on a processor (or devices enabled to process bytecodes) existing in a distributed environment (e.g., one or more processors on a network). A keyboard 1610 and mouse 1611 are coupled to a system bus 1618. The keyboard and mouse are for introducing user input to the computer system and communicating that user input to central processing unit (CPU 1613. Other suitable input devices may be used in addition to, or in place of, the mouse 1611 and keyboard 1610. I/O (input/output) unit 1619 coupled to bi-directional system bus 1618 represents such I/O elements as a printer, A/V (audio/video) I/O, etc.

Computer 1601 may be a laptop, desktop, tablet, smart-phone, or other processing device and may include a communication interface 1620 coupled to bus 1618. Communication interface 1620 provides a two-way data communication coupling via a network link 1621 to a local network 1622. For example, if communication interface 1620 is an integrated services digital network (ISDN) card or a modem, communication interface 1620 provides a data communication connection to the corresponding type of telephone line, which comprises part of network link 1621. If communication interface 1620 is a local area network (LAN) card, communication interface 1620 provides a data communication connection via network link 1621 to a compatible LAN. Wireless links are also possible. In any such implementation, communication interface 1620 sends and receives electrical, electromagnetic or optical signals which carry digital data streams representing various types of information.

Network link 1621 typically provides data communication through one or more networks to other data devices. For example, network link 1621 may provide a connection through local network 1622 to local server computer 1623 or to data equipment operated by ISP 1624. ISP 1624 in turn provides data communication services through the world wide packet data communication network now commonly referred to as the “Internet” 16216 Local network 1622 and Internet 16216 both use electrical, electromagnetic or optical signals which carry digital data streams. The signals through the various networks and the signals on network link 1621 and through communication interface 1620, which carry the digital data to and from computer 1600, are exemplary forms of carrier waves transporting the information.

Processor 1613 may reside wholly on client computer 1601 or wholly on server 16216 or processor 1613 may have its computational power distributed between computer 1601 and server 16216. Server 16216 symbolically is represented in FIG. 16 as one unit, but server 16216 can also be distributed between multiple “tiers”. In one embodiment, server 16216 comprises a middle and back tier where application logic executes in the middle tier and persistent data is obtained in the back tier. In the case where processor 1613 resides wholly on server 16216, the results of the computations performed by processor 1613 are transmitted to computer 1601 via Internet 16216, Internet Service Provider (ISP) 1624, local network 1622 and communication interface 1620. In this way, computer 1601 is able to display the results of the computation to a user in the form of output.

Computer 1601 includes a video memory 1614, main memory 1615 and mass storage 1612, all coupled to bi-directional system bus 1618 along with keyboard 1610, mouse 1611 and processor 1613.

As with processor 1613, in various computing environments, main memory 1615 and mass storage 1612, can reside wholly on server 16216 or computer 1601, or they may be distributed between the two. Examples of systems where processor 1613, main memory 1615, and mass storage 1612 are distributed between computer 1601 and server 16216 include thin-client computing architectures and other personal digital assistants, Internet ready cellular phones and other Internet computing devices, and in platform independent computing environments,

The mass storage 1612 may include both fixed and removable media, such as magnetic, optical or magnetic optical storage systems or any other available mass storage technology. The mass storage may be implemented as a RAID array or any other suitable storage means. Bus 1618 may contain, for example, thirty-two address lines for addressing video memory 1614 or main memory 1615. The system bus 1618 also includes, for example, a 32-bit data bus for transferring data between and among the components, such as processor 1613, main memory 1615, video memory 1614 and mass storage 1612. Alternatively, multiplex data/address lines may be used instead of separate data and address lines.

In one embodiment of the invention, the processor 1613 is a microprocessor such as manufactured by Intel, AMD, Sun, etc. However, any other suitable microprocessor or microcomputer may be utilized, including a cloud computing solution. Main memory 1615 is comprised of dynamic random access memory (DRAM). Video memory 1614 is a dual-ported video random access memory. One port of the video memory 1614 is coupled to video amplifier 1619. The video amplifier 1619 is used to drive the cathode ray tube (CRT) raster monitor 1617. Video amplifier 1619 is well known in the art and may be implemented by any suitable apparatus. This circuitry converts pixel data stored in video memory 1614 to a raster signal suitable for use by monitor 1617. Monitor 1617 is a type of monitor suitable for displaying graphic images.

Computer 1601 can send messages and receive data, including program code, through the network(s), network link 1621, and communication interface 1620. In the Internet example, remote server computer 16216 might transmit a requested code for an application program through Internet 16216, ISP 1624, local network 1622 and communication interface 1620. The received code maybe executed by processor 1613 as it is received, and/or stored in mass storage 1612, or other non-volatile storage for later execution. The storage may be local or cloud storage. In this manner, computer 1600 may obtain application code in the form of a carrier wave. Alternatively, remote server computer 16216 may execute applications using processor 1613, and utilize mass storage 1612, and/or video memory 1615. The results of the execution at server 16216 are then transmitted through Internet 16216, ISP 1624, local network 1622 and communication interface 1620. In this example, computer 1601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Thus, a method and apparatus for providing content from a plurality of sources is described.

What is claimed is:

1. A method of compositing video comprising:
Uploading a plurality of videos of an event to a server;
Synchronizing the videos and associating each video with a timeline;
Forwarding a subset of videos to a mobile device
Playing back the subset of videos on the mobile device;
Selecting start and stop points for each video by selecting one of the subset of videos during playback.

2. The method of claim 1 wherein the videos are recorded using a smart-phone.

3. The method of claim 2 wherein the videos are synchronized by identifying common audio data in each video.

4. The method of claim 3 wherein the subset of videos are provided to the mobile device at a lower resolution than the uploaded videos.

5. The method of claim 4 wherein the plurality of playback windows comprises a grid of playback windows.

6. The method of claim 5 wherein the user selects start and stop points by tapping on a touch-screen of the mobile device.

7. The method of claim 6 wherein the start and stop points are used to generate a composite video at the server.

8. The method of claim 7 wherein the composite video is assembled and transmitted to the mobile device at the resolution of the uploaded videos.

9. The method of claim 8 wherein a playback window is inactive if there is no video content available for that window.

10. A method of generating a composite video comprising:
Receiving a plurality of video clips associated with an event;
Synchronizing the video clips on a time line from the beginning of the earliest clip to the ending of the latest clip;
Automatically generating a composite video by selecting one of the plurality of clips at a plurality of edit points on the timeline.

11. The method of claim 10 wherein the one of the plurality of clips is selected randomly from clips available at each edit point.

12. The method of claim 10 wherein the one of the plurality of clips is selected based on a highest user rating of clips available at each edit point.

13. The method of claim 10 wherein the one of the plurality of clips is selected based on user preferences associated with clips available at each edit point.

14. The method of claim 10 wherein the one of the plurality of clips is selected based on extracted data associated with clips available at each edit point.

15. A method of rating a video comprising;
Playing a video on a device with a touch-screen;
Executing a hold tap gesture on the touch-screen during playback;
Saving the start and end time of when the gesture is executed;
Associating a rating with the portion of the video between the start time and end time.

16. The method of claim 15 further including presenting a user with an option to share the rated portion of content when the hold tap gesture is executed.

17. The method of claim 16 wherein the user may select a recipient with whom to share the rated portion of content.

18. The method of claim 17 wherein the recipient is a social media site.
